(19) United States
(12) Patent Application Publication
(10) Pub. No.: US 2016/0256937 A1
(43) Pub. Date: Sep. 8, 2016

(54) ROTARY TOOL AND METHOD FOR PRODUCING A ROTARY TOOL

(71) Applicant: Kennametal Inc., Latrobe, PA (US)

(72) Inventors: Tim GUTER, Zirndorf (DE); Juergen SCHWAEGERL, Vohenstrauss (DE); Julia TEMPELMEIER, Roth (DE)

(21) Appl. No.: 15/061,400

(22) Filed: Mar. 4, 2016

(30) Foreign Application Priority Data
Mar. 6, 2015 (DE) 102015204126.3

(51) Int. Cl. B23B 51/02; B24B 3/24

(52) U.S. Cl. CPC B23B 51/02; B24B 3/24; B23B 2251/046; B23B 2251/408

(57) ABSTRACT

The rotary tool, in particular, the drill (2), extends along a longitudinal axis (4) and has a front surface (6), a center (12), at least two main cutting edges (8), each extending outward from the center (12) to a cutting edge (10), as well as coiled flutes (20). Between the main cutting edge (8) and the flute (20), a common ground surface (26) is also applied, which extends from the center (12) to a radial exterior area in the region of the main cutting edge (8) to form a point thinning (28). A rake angle (γ) is defined by the ground surface (26). Here, the rake angle (γ) changes without steps in the direction of the center (12) and, in particular, continuously. Expediently, the ground surface extends (26) continuously to the cutting edge (10). As a result, on the whole, an advantageous cutting force distribution is achieved over the radial length of the main cutting edge (8).

### RELATED APPLICATION DATA

The present application claims priority pursuant to 35 U.S.C. §119(a) to German Patent Application Number 102015204126.3 filed Mar. 6, 2015 which is incorporated herein by reference in its entirety.

### FIELD

The invention relates to a rotary tool, in particular a drill, with the features of the preamble of Claim 1, and a method for producing such a rotary tool.

### BACKGROUND

In EP 1 748 859 B1, a so-called spade drill is described, in which two main cutting edges in the region of a center are connected via a chisel edge. The main cutting edges lie on a common horizontal face plane. Furthermore, the main cutting edges run in a straight line. In the area of the center and of the chisel edge, a point thinning is incorporated by means of a separate grinding step, wherein the ground surface developing in the process extends outward in a radial direction to a cutting edge and forms a cutting surface which is oriented at a rake angle. Blind holes with a flat drilled base can be reliably produced using such a spade drill.

### SUMMARY

Proceeding from this, the task underlying the invention is the provision of a rotary tool, in particular, a drill, which facilitates good cutting performance.

The task is solved in accordance with the invention by a rotary tool with the features of Claim 1 and a method with the features of Claim 14. The rotary tool is designed, in particular, as a drill and extends along a longitudinal axis. At the front end, a front surface is designed, on which at least one and preferably at least two main cutting edges are located, which extend in radial direction from a cutting edge to an internal center. The rotary tool is a grooved tool with at least one flute per main cutting edge. The center is formed by a central material core of the drilling tool. At the front surface, the drill ends at a center tip, which lies on the longitudinal axis. At the same time, the longitudinal axis also defines a rotational axis around which the rotary tool rotates during operation. In addition to the usually ground flute, a further common ground surface is applied by means of an additional grinding step. This common ground surface extends from the center to a radially exterior region in the area of the main cutting edge. In the center, the ground surface forms a point thinning and, in the further course of the main cutting edge, the ground surface forms and defines the rake angle. The rake angle formed by the ground surface changes without steps and, in particular, continuously in the direction of the center. Alternately to a continuous change, the rake angle can also be constant over a certain radial segment, wherein the radial segment with the constant rake angle extends, for example, over a range of a few percent, in particular, of a maximum of 15% or of a maximum of 50% of the nominal radius.

Here, rake angle means the angle between a vertical plane extending in the direction of the longitudinal axis and the ground surface. This is formed by the application of the ground surface. Thus, the main cutting edge and the adjoining area of the flute are ground in the corresponding grinding step.

Changing the rake angle without steps means, in particular, that neither the ground surface nor the main cutting edge in the area of the ground surface has a kink, that is, an edge. In other words, the change of the rake angle is continuous in a radial direction toward the center (Δγ/Δr) and thus has no discontinuity. In the process, the rake angle changes, in particular, exclusively in one direction, i.e. it does not increase and decrease alternately. In particular, the rake angle decreases toward the center. From a manufacturing standpoint, this is achieved by a corresponding actuation of a grinding disk so that a set angle of the grinding disk relative to the rotary tool is preferably adjusted free of steps to the continuous change of the rake angle. The term “free of steps”, in particular, involves an incremental approximation to such a continuous change of the set angle, i.e. the grinding disk is engaged at different angles so that, on a microscopic level, slight ground edges are produced at two adjoining partial ground surfaces. At the ground edge, however, the two partial ground surfaces deviate slightly, at the most, e.g. by a maximum of about 3°, from a flush 180° alignment of the two partial ground surfaces. Thus, in the case of an incremental approximation, multiple, in particular, more than 3 and preferably more than 5, such ground edges and a corresponding number of partial ground surfaces are formed within the ground surface.

In an appropriate design, the change is continuous, i.e. the change of the rake angle for every cutting edge section is not equal to zero. Thus, there are no cutting edge sections that have a consistent rake angle over the entire section.

In addition, the feature that the ground surface extends to an exterior radial area means, in particular, that the ground surface running from the center, that is, from the rotational axis, extends over at least 50% or 60%, and preferably over at least 80%, of a nominal radius of the rotary tool.

Due to the design with the additional ground surface, on the one hand, the development of a rake angle separate from the previously ground flute is made possible so that, due to the additional common ground surface, a suitable rake angle can easily be ground for the respective machining purpose regardless of the formation of the flute. A further critical advantage can be seen in the changing rake angle. On the one hand, due to the common, uniform and edge-free ground surface, it is ensured that no kinks are formed in spite of the variation of the rake angle in the area of the ground surface. Ordinarily, there is such a kink in the transition area to the point thinning. This is prevented by the common ground surface. On the whole, this leads to a homogeneous cutting force behavior over the entire length of the cutting edge of the drill.

Due to the varying rake angle, there is an additional particular advantage that, simultaneously with this homogeneous behavior, the cutting force varies advantageously, for example, from a sharp-edged cutting edge to a rather dull center. As a result, the individual cutting edge sections can be adapted especially advantageously to the anticipated loads in the machining process and/or the maximum loads of the rotary tool.

In a preferred embodiment, the ground surface, starting from the cutting edge, also extends continuously at least to the center. This method ensures that there are no kinks over the entire main cutting edge section. As a result, there is a completely homogenous cutting force behavior without discontinuities over the entire length of the cutting edge.

In principle, it is possible to design the cutting edge with a corner shape and/or with a secondary cutting edge shape, for example to form a chamfer or a radius or a rounded edge. This corner or secondary cutting edge shape is designed, for example, as a simple oblique ground surface. In such a case, the ground surface likewise extends to the cutting edge, whose threshold is defined by the corner shape.

Alternately to the ground surface extending to the cutting edge, the ground surface ends before the cutting edge so that, at the extreme edge of the radial area, the original flute wall extends to the main cutting edge and thus also defines the rake angle. In the case of this variant, the changing course of the rake angle is preferably selected in such a way that it is also free of steps, that is, has no kinks or edges, in the sense of the above definition of without steps, at the transition point to the original flute. Thus, the ground surface merges into the original existing flute wall without kinks.

In a preferred embodiment, a positive rake angle is formed at the cutting edge so that a sharp cutting wedge is created. In the preferred embodiment, the rake angle decreases in the direction of the center.

In the area of the center, that is, in particular, in the area where the main cutting edge merges into the chisel edge, the rake angle assumes only small values, for example, from −5° to +10°, and preferably a maximum of +2°, and has, in particular, a value of zero. A positive sign of the rake angle means that an acute cutting wedge is formed and a negative value means that an obtuse cutting wedge is formed. By selecting the in any case very small rake angles or even slightly negative rake angles in the center, the cutting edge formed there is broadly obtuse overall so that, on the whole, it is very robust in the region of the center.

It is also provided that the rake angle on the radially outermost section of the ground surface and hence, in particular, on the cutting edge, is in the range of from 5° to 20° or 30° and, in particular, approximately from 10° to 15°, and preferably 15°. As a result, a comparatively sharper cutting wedge is formed on the cutting edge overall so that, in the region of the cutting edge, the drill cuts extremely well on the whole, whereas, due to the small rake angle in the center region, the cutting edge there does not cut as well and is designed to be blunt. In principle, the rake angle on the cutting edge is limited by a flute angle. Thus, depending on the selection of the flute angle, the rake angle on the cutting edge can also be greater than 20° and can assume a value up to a maximum of the flute angle. Ordinarily, this is a maximum of 30°. Flute angle means the angle at which the flute is oriented with respect to a vertical direction. Thus, in the case of a coiled flute, the flute angle also indicates the spiral inclination. The flute angle is also called the angle of twist.

In an appropriate embodiment, the main cutting edges continue to run in a radial direction in a straight line, that is, they do not follow an arched pathway. At the same time, in combination with the varying rake angle, the desired cutting forces defined for the individual cutting edge sections can be specified.

In principle, however, the advantage of the varying rake angle can also be achieved by means of the common ground surface where the main cutting edges are arched. Thus, in a preferred alternative, the main cutting edge is designed, in particular, as having a concave arch.

The flute is generally a coiled flute which runs at the flute angle. In the case of a conventional drill, the rake angle on the main cutting edge is determined by this flute angle. Due to the additional ground surface applied in the area of the main cutting edge, the rake angle is formed separately from the flute angle.

At the same time, as a characteristic feature, a kink is formed in the flute wall in the transition area of the ground surface to the further course of the flute wall, due to the additionally applied ground surface.

In accordance with a preferred improvement, the ground surface extends over the entire flute, that is, extends from the cutting edge over the center to the opposite end of the flute. This embodiment facilitates easy grinding of the ground surface.

Expediently, it is provided that the front surface, on the whole, is preferably formed as a cone-shaped outer surface. In general, the front surface is preferably only interrupted by the flutes extending into the front surface. Thus, starting from a center tip, open areas of the front surface slope outward in a radial direction. Here, the open areas adjoin the main cutting edges in a circumferential direction at the face. Here, “as a cone-shaped outer surface” means different ground surface variants, such as the relieved cone, as well as multiple surface grinding, such as four facet grinding. The essential advantage compared to a spade drill, for example, can be seen in that a center tip is available for center drilling and, as a result, better guidance of the drill is achieved at the beginning of the drilling process.

### BRIEF DESCRIPTION OF THE DRAWINGS

An exemplary embodiment of the invention is described in greater detail in the following by reference to the figures. The figures show simplified representations of the following:

FIG. 1 a frontal view of a drill,

FIG. 2 a first lateral view of a section of a cutting edge of the drill according to FIG. 1

FIG. 3 a second lateral view of a section of the drill according to FIG. 1, turned by approximately 90° in comparison with FIG. 2

FIG. 4 a lateral view of a section of a vertical radially outer sectional plane along a line of intersection IV-IV in FIG. 1, in the same viewing direction as FIG. 2, and

FIG. 5 a lateral view of a section of a vertical radially inner sectional plane along a line of intersection V-V in FIG. 1, in the same viewing direction as FIG. 2.

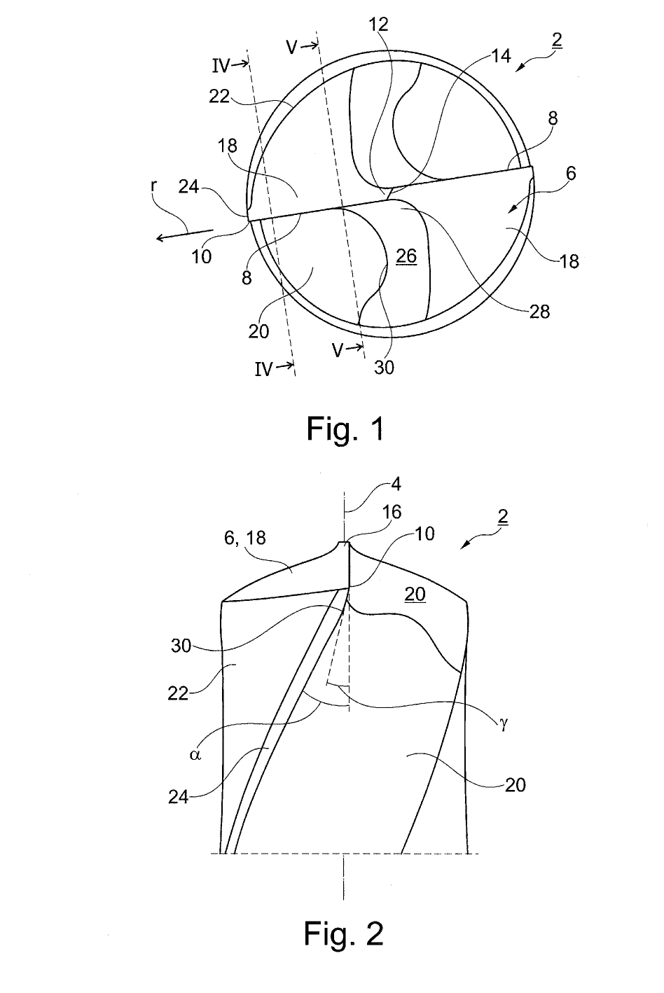

### DETAILED DESCRIPTION

The rotary tool shown in the figures is designed as a drill 2, which extends along a longitudinal axis 4, which, at the same time, forms a rotational axis, extending in a longitudinal direction. The drill 2 has an essentially conical front surface 6. In the exemplary embodiment, the drill has two main cutting edges 8, each extending in a straight line from an outer cutting edge 10 to a center 12. The two main cutting edges 8 are typically connected to one another in the center 12 via a chisel edge 14. As can be seen in the lateral views in particular, the drill 2 has a somewhat convex center tip 16 in the center 12. This is typically crossed by the chisel edge 14.

Due to their rectilinear course and the rotational symmetry, according to which the two main cutting edges 8 are rotationally offset by 180° with respect to the longitudinal axis 4, the two main cutting edges 8 run parallel to one another. An open area 18 adjoins each of the main cutting edges 8, each forming a part of the front surface 6. The essentially conical front surface 6 is interrupted by flutes 20. The flutes 20 in the exemplary embodiment extend along the drill 2 in the shape of a spiral. At the same time, they are oriented at a flute angle α with respect to a vertical direction (cf. FIG. 2).

A ridge of the drill 22 is formed between each of the flutes 20 on the circumference. In the exemplary embodiment, a margin 24 is arranged in the transition area from the flute 20 to the ridge of the drill 22.

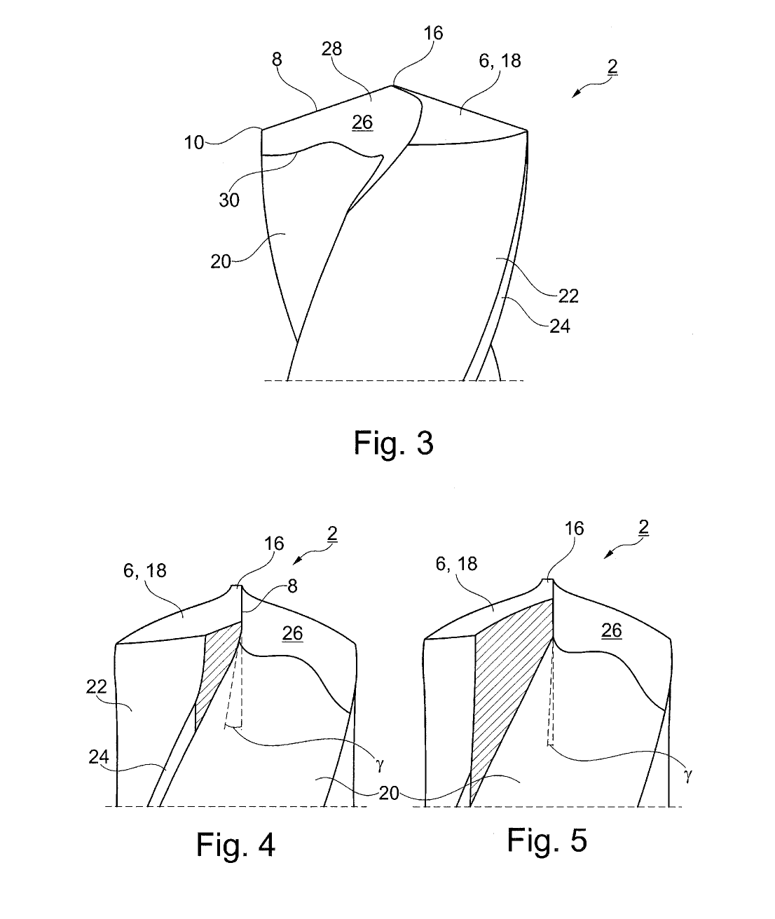

As can be seen in the lateral view according to FIGS. 2 and 3, in particular, a ground surface 26 is applied at the front end of the flute 20. Starting at the center 12, this ground surface extends as a uniform surface toward the cutting edge 10 and reaches at least an outer radial area in the area of the flute. At the same time, the ground surface 26 preferably extends at least to the middle of the main cutting edge 8 and preferably, as shown in the figures, to the cutting edge 10. In the exemplary embodiment, in the transition area on the front end of the flute 20, the ground surface also extends to the front surface 6 over the entire flute 20, that is, from the cutting edge 10 to the opposite end of the flute 20, where it merges into the ridge of the drill 22.

This ground surface 26 forms a point thinning 28 in the area of the center 12. Since the ground surface 26 continues running in a radial direction, in particular, continuously, to the outer cutting edge 10, it also defines a rake angle γ of the main cutting edge 8. This rake angle is fixed as the angle between a vertical direction and the ground surface 26, as shown, for example in FIG. 2, 4 and FIG. 5.

At the same time, the rake angle γ is formed on the cutting edge 10 as a positive rake angle so that an acute-angle cutting wedge is present. Due to the grinding of the ground surface 26, the flute wall is somewhat reduced in the area of the front surface 6 and the main cutting edge 8 is also ground. As a result, the flute angle α of the coiled flute 20 is reduced so that the rake angle γ is less than the flute angle α. In general, the rake angle γ reaches, at the maximum, the flute angle α, which can be as much as 30°, for example. Preferably, the rake angle γ on the cutting edge ranges from about 10° to 15°.

As a comparison of FIGS. 2, 4 and 5 makes particularly clear, the rake angle γ is reduced in the direction of the center 12. The change Δγ/Δr of the rake angle γ in a radial direction r is continuous so that a ground surface 26 free of kinks is formed and thus also a main cutting edge 8 that is free of kinks. Preferably, the rake angle γ changes continuously. In the center 12 itself, that is, in the area of the point thinning 28, and hence in the transition area between the main cutting edge 8 and the chisel edge 14, the rake angle γ is preferably zero or is even slightly negative, for example, up to −5°. Due to this arrangement, the drill 2 in the area of the corner cutting edge 10 cuts better on the whole, due to the sharper cutting wedge, than in the center 12, which has a positive overall effect on the cutting performance and the required force for the machining. On the other hand, due to the reduction to a range of about 0° for the rake angle γ in the center 12, an essentially solid wedge is formed, which is very well able to withstand the loads occurring in the center 12 during machining.

From a manufacturing standpoint, the approach here is to apply the ground surface 26 subsequently to the respective flute 20. A grinding disk is used for this, which is set at a specified angle so that the desired rake angle γ is formed. The grinding disk is adjusted in a radial direction r during the grinding process and, in the process, the relative angular position between the drill 2 and the grinding disk is continuously adjusted so that the varying rake angle γ in a radial direction r comes about as a result.

Alternately to the embodiment of the invention outlined here, there is also the option of not carrying the ground surface 26 completely through to the cutting edge 10. In this variant, the ground surface 26 therefore ends at a radial distance from the cutting edge 10. This distance amounts to a maximum of 60% or 50%, and preferably a maximum of 20%, of a nominal drill radius. This is defined as the radius of the rotational and longitudinal axis 4 to the cutting edge 10.

Due to the additional subsequent placement of the ground surface 26, a kink 30 forms in the transition area between the ground surface 26 and the further flute wall, as can be seen, in particular, in the area of the margin 24 in FIG. 2. Here, the difference between the rake angle γ and the flute angle α can also easily be seen.

On the whole, due to the common ground surface 26, which is subsequently applied to the flute 20, and the continuously changing rake angle γ, an improved cutting force distribution over the radial length of the main cutting edge 8 is achieved. In particular, due to the uniform homogenous, kink-free course, tension peaks are not to be feared; on the contrary, the force acting on the cutting edge changes uniformly.

1. Rotary tool, which extends along a longitudinal axis, with
a front surface,
a center,
at least one main cutting edge extending outward from the center to a cutting edge,
a flute,
a rake angle (γ) between the main cutting edge and the flute,
an additional common ground surface applied in the flute, which forms a point thinning in the region of the center and extends to a radially outer area and defines the rake angle (γ) in the area of the main cutting edge, wherein the rake angle (γ) formed by the ground surface changes without steps in the direction of the center.

2. The rotary tool of claim 1, wherein starting from the cutting edge, the ground surface extends continuously at least to the center.

3. The rotary tool of claim 1, wherein a positive rake angle (γ) is formed on the cutting edge, which decreases in the direction of the center and wherein the rake angle (γ) changes continuously over a radial segment.

4. The rotary tool of claim 1, wherein a positive rake angle (γ) is formed on the cutting edge, which decreases in the direction of the center and wherein the rake angle (γ) is constant over a radial segment.

5. The rotary tool of claim 1, wherein a positive rake angle (γ) is formed on the cutting edge, which continuously decreases in the direction of the center.

6. The rotary tool of claim 1, wherein the rake angle (γ) in the region of the center ranges from −5° to +10°.

7. The rotary tool of claim 1, wherein the rake angle (γ) in the region of the center is zero.

8. The rotary tool of claim 1, wherein the rake angle (γ) on the cutting edge ranges from 5 to 30°.

9. The rotary tool of claim 1, wherein the rake angle (γ) on the cutting edge ranges from 10° to 15°.

10. The rotary tool of claim 1, wherein the main cutting edge extends in a straight line.

11. The rotary tool of claim 1, wherein the main cutting edge is arched.

12. The rotary tool of claim 1, wherein the flute is coiled.

13. The rotary tool of claim 1, wherein the ground surface, viewed in the direction of the longitudinal axis, merges into the further flute over a kink.

14. The rotary tool of claim 1, wherein the ground surface extends over the entire flute in a radial direction.

15. A method for producing a rotary tool of claim 1 in which the ground surface, for forming the common point thinning and for forming the rake angle (γ), is applied in the existing flute in the region of the main cutting edge in a single grinding step.
